(19) United States
(12) Patent Application Publication
(10) Pub. No.: US 2008/0225280 A1
(43) Pub. Date: Sep. 18, 2008

(54) SURFACE FLATNESS TESTING DEVICE AND METHOD THEREOF

(75) Inventors: SHUN JIANG, Shenzhen (CN); GUI-LI DONG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 11/845,789

(22) Filed: Aug. 28, 2007

(30) Foreign Application Priority Data
Mar. 13, 2007 (CN) 200710200268.X

(51) Int. Cl. G01N 21/88

(52) U.S. Cl. 356/237.2

(57) ABSTRACT

An exemplary surface flatness testing device (10) includes a light emitting unit (11), a light receiving unit (12), a platform (13), an adjusting unit (14) and a processing unit (15). The light receiving unit faces the light emitting unit. The platform is located between the light emitting unit and the light receiving unit, which is configured for holding a workpiece (18) having a testing surface (181). The adjusting unit is disposed between the light emitting unit and the light receiving unit. The adjusting unit and the testing surface of the workpiece are controlling light from the light emitting unit to the light receiving unit. The processing unit is configured for processing signals from the light receiving unit. The present invention also provides a surface flatness testing method.

### BACKGROUND OF THE INVENTION

1. Field of the Invention

The present invention relates to surface flatness testing devices and methods, and more particularly to a non-contact surface flatness testing device and method.

2. Discussion of the Related Art

In the manufacturing industry, the surface flatness of a workpiece is important for reasons of aesthetic and for assembly with other workpieces. Thus the need for testing the surface flatness of workpieces is important. One method for testing surface flatness is by using a thickness gauge and a standard testing platform.

Typically, a surface flatness testing method using a thickness gauge and a standard platform includes the following steps: placing a workpiece on the standard platform with the testing surface of the workpiece facing the standard platform, the flatness of the workpiece is determined by noting gaps between the surface of the workpiece under-test and the surface of the platform; the gaps are marked and the magnitude of the gaps are checked with the thickness gauge, the measured magnitude of the gaps are then compared to acceptable tolerance and the workpiece is discarded or retained based on the acceptable tolerance.

The surface flatness testing method using the thickness gauge and the standard platform is uncomplicated and relatively inexpensive. However, the precision of this method is low because empirical data shows that the error using this method is, generally, about 0.02 millimeters. Also, if many workpiece need to be check continuously, operator errors may increase. Further, during testing, the testing surface of the workpiece makes contact with the standard platform and the thickness gauge and thus, the testing surface, the standard platform, and the thickness gauge are prone to abrasions. Consequently, these abrasions will affect the appearance of the workpieces, the platform and the thickness gauge may wear out early. This wearing out will affect the precision of the standard platform and the thickness gauge, resulting in an increase in testing errors.

Therefore, a new surface flatness testing device and a new surface flatness testing method are desired in order to overcome the above-described shortcomings.

### SUMMARY

A surface flatness testing device includes a light emitting unit, a light receiving unit, a platform, an adjusting unit and a processing unit. The platform is located between the light emitting unit and the light receiving unit, which is configured for receiving a workpiece having a testing surface. The adjusting unit is disposed between the light emitting unit and the light receiving unit. The adjusting unit and the measuring surface of the workpiece is controlling light from the light emitting unit to the light receiving unit. The processing unit is configured for processing light information from the light receiving unit.

Other advantages and novel features will become more apparent in the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present new surface flatness testing device and method. Moreover, in the drawings, like reference numerals designate corresponding parts throughout the several views, and all the views are schematic.

FIG. 1 is an isometric view of part of a surface flatness testing device according to a first preferred embodiment of the present invention, showing a workpiece on a platform.

FIG. 2 is a cross-sectional, explanatory view of working principle of the surface flatness testing device of FIG. 1, taken along line A-A thereof.

FIG. 3 is an explanatory view of working principle of a surface flatness testing device according to a second preferred embodiment of the present invention.

FIG. 4 is an explanatory view of working principle of a surface flatness testing device according to a third preferred embodiment of the present invention.

### DETAILED DESCRIPTION OF THE PREFERRED EMBODIMENTS

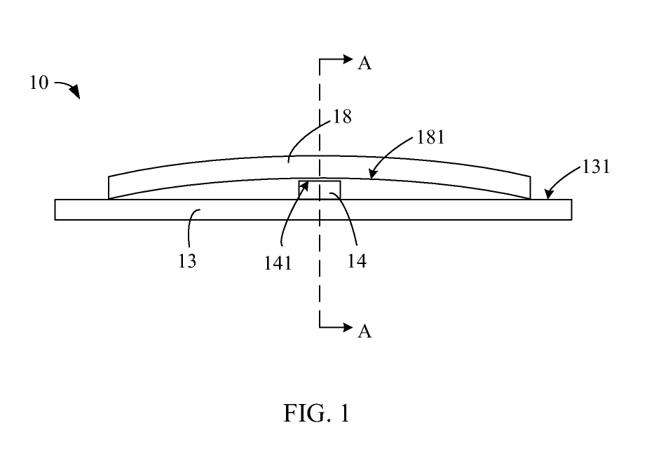

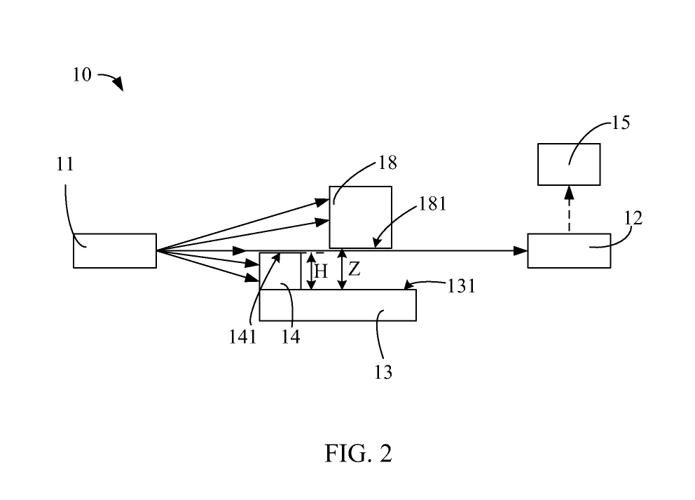

Referring to FIGS. 1 and 2, a surface flatness testing device 10 according to a first preferred embodiment of the present invention is shown. The surface flatness testing device 10 includes a light emitting unit 11, a light receiving unit 12, a platform 13, an adjusting unit 14, and a processing unit 15. The light receiving unit 12 faces the light emitting unit 11. In a described embodiment, the platform 13 is located between the light emitting unit 11 and the light receiving unit 12, and having the flat surface 131 receive workpiece 18 to test a flatness of a testing surface 181 of the workpiece 18. The axis that joins a light receiving center of the light receiving unit 12 and a light emitting center of the light emitting unit 11 is parallel to the flat surface 131 of the platform 13. The workpiece 18 can be a block, a sheet, or a frame. The testing surface 181 of the workpiece 18 is adjacent to the platform 13. The adjusting unit 14 can be also described as a flatness deviation acceptance adjusting unit, which is used to adjust an acceptable error of the surface flatness of the test. In the described embodiment, the adjusting unit 14 is a solid block with a top flat surface 141, and configured to allow light rays traveling parallel to the top flat surface 141 to pass through a gap between the workpiece 18 and the platform 13. In other words, the adjusting unit 14 is used as a barrier for light traveling below the top flat surface 141, and allows light traveling at a predetermined path at a predetermined height above the platform 13. The adjusting unit 14 is disposed on an end of the platform 13 adjacent to the light emitting unit 11. A transverse cross-section of the adjusting unit 14 is rectangular. The processing unit 15 is a programmable controller configured for processing signals received from the light receiving unit 12. The signals can be a magnitude of light intensity of the light projecting to the light receiving unit 12, or a distribution of light intensity if many portions of the testing surface 181 are tested.

The light emitting unit 11 can either be a point light source or a linear light source. The light receiving unit 12 includes a photoelectric converter. The photoelectric converter can be a photosensitive resistance, a complementary metal oxide semiconductor (CMOS), or a charge couple device (CCD).

A predetermined distance value H between the top surface 141 of the adjusting unit 14 and flat surface 131 of the platform 13 is configured to be a flatness deviation acceptance value according to specification of the workpiece 18. In other words, as long as the flatness of the testing surface 181 does not deviate more than the predetermined distance value H, the testing surface 181 is determined to be flat. The workpiece 18 is placed on the platform 13 such that the testing surface 181 of the workpiece 18 is adjacent to the platform 13. The light emitting unit 11 is then turned on. If a distance value Z between a portion of the testing surface 181 and flat surface 131 is greater than the predetermined distance value H, the light would travel through a region between the testing surface 181 and the top surface 141 to the light receiving unit 12. If the distance value Z between the portion of the testing surface 181 and flat surface 131 is smaller than the predetermined distance value H, the light would not be able to travel through the region to the light receiving unit 12. The processing unit 15 processes the signals from the light receiving unit 12, and computes whether the surface flatness of the testing surface 181 is within acceptable limits or not within acceptable limits. For example, if the light reaches the light receiving unit 12, the flatness of the testing surface 181 meets the specification for the workpiece 18; if not, the flatness of the testing surface 181 is beyond the acceptable limits.

While testing the flatness of the testing surface 181, measurements of the flatness of the testing surface 181 is done by the processing unit 15, thereby eliminating the uncertainties of human's measuring precision. Further, the precision of testing the flatness of the testing surface 181 is enhanced because of the use of light rays. In addition, during the flatness testing, the testing surface 181 only comes in contact with the platform 13, thus damages to the testing surface 181 of the workpiece 18 due to scratches and abrasions are kept to the minimum.

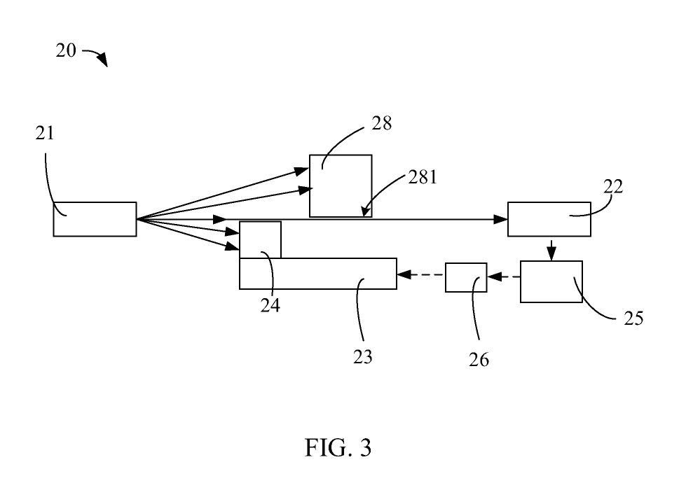

Referring to FIG. 3, a flat surface testing device 20 according to a second embodiment is shown. The surface flatness testing device 20 is similar in principle to the surface flatness testing device 10 of the first embodiment. The surface flatness testing device 20 includes a light emitting unit 21, a light receiving unit 22, a platform 23, an adjusting unit 24, and a processing unit 25. Further, the surface flatness testing device 20 includes a driving unit 26 connecting, such as electrically connect to the platform 23, and the processing unit 25. In use, the driving unit 26 can be configured for driving the platform 23 to move according to controlling signals from the processing unit 25. Thus the surface flatness testing device 20 can obtain more information about a surface flatness of a testing surface 281 of a workpiece 28. It should be understood that the driving unit 26 is electrically connected to the platform 23 and the driving unit 26 is configured to move along a predetermined moving path of the platform 23.

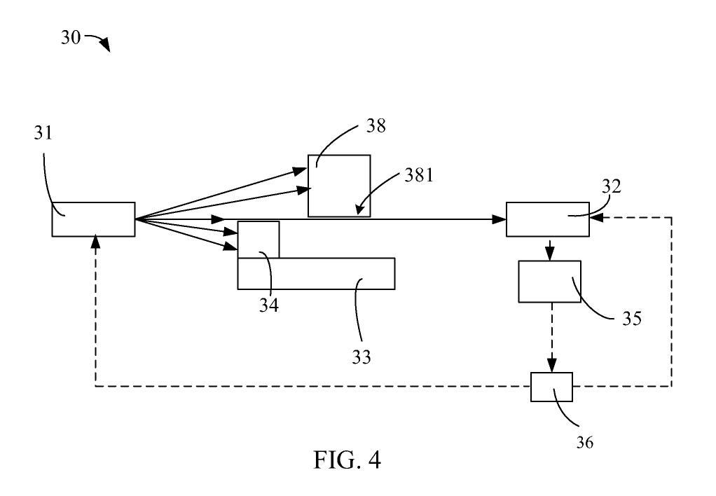

Referring to FIG. 4, a surface flatness testing device 30 according to a third embodiment is shown. The surface flatness testing device 30 is similar in principle to the surface flatness testing device 10 of the first embodiment. The surface flatness testing device 30 includes a light emitting unit 31, a light receiving unit 32, a platform 33, a adjusting unit 34, and a processing unit 35. Further, the surface flatness testing device 30 includes a driving unit 36 electrically connected to the light emitting unit 31, the light receiving unit 32, and the processing unit 35. In use, the driving unit 36 can be configured for driving the light emitting unit 31 and the light receiving unit 32 to move simultaneously according to controlling signals from the processing unit 35. Thus the surface flatness testing device 30 can obtain more information about a surface flatness of a testing surface 381 of a workpiece 38. It should be understood that the driving unit 36 can only electrically connect to the light emitting unit 31 and the light receiving unit 32 and the light emitting unit 31 and the light receiving unit 32 are configured to move along a predetermined moving path.

It is noted that the scope of the present surface flatness testing devices is not limited to the embodiments described above. For example, the transverse cross-section of the adjusting unit can be a triangle. The adjusting unit can be disposed opposite to the platform, and the testing surface of the workpiece do not contact with the platform, thus the testing surface of workpiece is further prevented from scratches and abrasions. In addition, the above surface flatness testing devices can also be utilized for testing surface warp of the workpiece. When the above surface flatness testing devices is utilized for testing surface warp of the workpiece, the light emitting unit and light receiving unit can have multiple pairs for improving a testing efficiency.

While various preferred and exemplary embodiments have been described, the embodiments can further be modified within the spirit and scope of this disclosure. This application is therefore intended to cover any variations, uses, or adaptations of the embodiments using the general principles of the invention as claimed. Further, this application is intended to cover such departures from the present disclosure as come within known or customary practice in the art to which the invention pertains and which fall within the limits of the appended claims or equivalents thereof.

What is claimed is:

1. A surface flatness testing device comprising:
a light emitting unit;
a light receiving unit corresponding to the light emitting unit;
a platform located between the light emitting unit and the light receiving unit, the platform configured for receiving a workpiece having a testing surface;
an adjusting unit disposed between the light emitting unit and the light receiving unit, the adjusting unit and the testing surface of the workpiece cooperatively controlling light from the light emitting unit to the light receiving unit; and
a processing unit configured for processing signals from the light receiving unit.

2. The surface flatness testing device as described in claim 1, wherein a transverse cross-section of the adjusting unit is a rectangle or a triangle.

3. The surface flatness testing device as described in claim 1, wherein the platform comprises an end adjacent to the light emitting, and the adjusting unit is located at the end of the platform.

4. The surface flatness testing device as described in claim 1, wherein the light receiving unit has a photoelectric converter, and the photoelectric converter is one of a photosensitive resistance, a complementary metal oxide semiconductor, and a charge couple device.

5. The surface flatness testing device as described in claim 1, wherein the surface flatness testing device further comprises a driving unit using for driving the platform to move.

6. The surface flatness testing device as described in claim 5, wherein the driving unit connects to the processing unit, the driving unit configured for driving the platform to move according to controlling signals from the processing unit.

7. The surface flatness testing device as described in claim 1, wherein the surface flatness testing device further comprises a driving unit connecting to the light emitting unit and the light receiving unit, the driving unit configured for driving the light emitting unit and the light receiving unit to move simultaneously.

8. The surface flatness testing device as described in claim 7, wherein the driving unit connects to the processing unit, the driving unit configured for driving the light emitting unit and the light receiving unit to move simultaneously according to controlling signals from the processing unit.

9. The surface flatness testing device as described in claim 1, wherein the signals are distribution of light intensity or magnitude of light intensity of the light reaches the light receiving unit.

10. The surface flatness testing device as described in claim 1, wherein the workpiece is a sheet, a block or a frame.

11. A surface flatness testing method comprising:
placing a workpiece having a testing surface on a platform of a surface flatness testing device, the surface flatness testing device comprising a light emitting unit; a light receiving unit corresponding the light emitting unit; the platform located between the light emitting unit and the light receiving unit; an adjusting unit disposed between the light emitting unit and the light receiving unit, the adjusting unit and the testing surface of the workpiece cooperatively controlling light from the light emitting unit to the light receiving unit; and a processing unit configured for processing signals from the light receiving unit;
turning on the light emitting unit, light from the light emitting unit projecting at a region between the testing surface and the adjusting unit, the light receiving unit receiving the light passing through the region; and
processing signals from the light receiving unit in the processing unit thereby obtaining a result of flatness of the testing surface.

12. The surface flatness testing method as described in claim 11, wherein the testing surface of the workpiece faces the platform.

13. The surface flatness testing method as described in claim 11, wherein the signals are distribution of light intensity or magnitude of light intensity of the light projecting to the light receiving unit.

14. The surface flatness testing method as described in claim 11, wherein the surface flatness testing method further comprises a step of configuring a distance between the platform and the test parameter adjusting unit, before the step of turning on the light emitting unit.
